(19) United States
(12) Patent Application Publication
(10) Pub. No.: US 2006/0112239 A1
(43) Pub. Date: May 25, 2006

(54) Memory device for use in a memory module

(76) Inventor: Hermann Ruckerbauer, Moos (DE)

Correspondence Address: PATTERSON & SHERIDAN, LLP;Gero McClellan / Infineon Technologies, 3040 POST OAK BLVD.,, SUITE 1500, HOUSTON, TX, 77056, US

(21) Appl. No.: 10/993,165

(22) Filed: Nov. 19, 2004

(51) Int. Cl. G06F 13/00

(52) U.S. Cl. 711/154

(57) ABSTRACT

A memory device for use in a memory module and method for operating the memory device are provided. In one embodiment, the memory device comprises a memory array, a memory access logic for controlling access to the memory array depending on a command data, a command interface for establishing a point to point interconnect to a memory controller and comprising a first and a second command port for receiving first and second command signals indicating the command data and, a repeater unit for receiving the first command signal via the first command port and for forwarding the first command signal to a forwarding port.

### BACKGROUND OF THE INVENTION

1. Field of the Invention

The present invention is related to a memory device for use in a memory module and a memory module including a number of memory devices.

2. Description of the Related Art

In a conventional memory module, data is transferred to and from the memory devices on the module via a single data bus. All data including command data and address data are transferred via respective common bus lines to all of the memory devices of the module. In Double Data Rate (DDR) Technology, data are provided to the memory devices via a hybrid T-bus (DDR-2) or a Fly-By bus, wherein the data on the bus lines is substantially delivered to each of the memory devices. With increasing transfer data rates on the command and address bus lines, these bus concepts are no longer appropriate as the distributed capacity of the input ports of the several memory devices substantively limits the data rate on the bus lines.

In future memory technologies, such as DDR-4, point-to-point or point-to-2-points interconnections between the memory controller and the memory devices on the memory module were proposed in order to overcome the data rate restriction provided by the hybrid T-bus and the Fly-By bus concept. Using a point-to-point interconnection from a memory controller to each of the memory devices, command and address information is transferred to each of the memory devices on the module redundantly, so that a large number of bus lines is required. Particularly, with an increasing number of memory devices on the modules as well as an increasing number of memory modules in a computer system, the area for the bus lines requires a large portion of the system printed circuit board area.

Therefore, there is a need to reduce the number of bus lines used for interconnections between a memory controller and the memory devices on a memory module.

### SUMMARY OF THE INVENTION

According to a first aspect, a memory device for use in a memory module is provided. The memory device includes a memory array, a memory access logic for controlling access to the memory array depending on a command data, and a data interface for establishing an interconnect, as e.g., a point-to-point or a point-to-2-points interconnection to a memory controller, and comprising a first and a second command port for receiving first and second command signals indicating the command data. Furthermore, the memory device includes a repeater unit for receiving the first command signal via the first command port and for forwarding the first command signal to a forwarding port.

The memory device according to one embodiment of the present invention allows sharing a command signal received via an interconnection from, e.g., a memory controller, with a further memory device connected to the forwarding port.

The memory device allows for the creation of a memory module including a number of such memory devices wherein an interconnection command line is provided connecting the forwarding port of a first of the memory devices to a second command port of a second of the memory devices. Thereby, it is possible that the command signal, being a part of the command data, is shared between the first and the second of the memory devices. In such a way, the number of interconnection lines between the memory controller and the memory devices in a point-to-point interconnection system can be reduced substantively.

According to an embodiment of the present invention, the command interface comprises an address/data port for receiving an address and/or data information.

Furthermore, the memory device may comprise a configuration register to store a command restore information and a command assembly unit for assembling the command data from the first and the second command signal depending on the command restore information. Thereby, it is possible to provide information to the memory device by means of which the first and the second command signal may be assembled to obtain the command data necessary to access the memory array.

In a further embodiment, the memory device is a dynamic random access memory (DRAM) device. The first and/or second command signals may be assembled to comprise a command signal in the group of DRAM command signals, such as a Row-Activate-Signal (RAS-Signal), a Column-Activate-Signal (CAS-Signal), a Write-Enable-Signal (WE-Signal) and a Chip-Select-Signal (CS-Signal).

According to one embodiment, the memory module includes a further interconnection command line which connects a forwarding port of the second of the memory devices to a second command port of the first of the memory devices. By means of the interconnection command line and the further interconnection command line, the first and second memory devices of the memory module are coupled such that each of the memory devices obtains a part of the command data which is received by the respective other of the first and second memory devices. Thereby, the number of command signals provided to each of the memory devices is reduced so that each memory device only receives a part of the command data wherein this respectively received part of the command data is forwarded to the respective other first and second memory device.

Furthermore, it can be provided that the interconnection command line is further connected to a first command port of a third of the memory devices. The further interconnection command line can be further connected to the second command port of the third of the memory devices. Thereby, a memory device is provided for receiving command signals via the first and the second memory devices without being supplied with command signals provided by, e.g., the memory controller.

According to another embodiment, each memory device of the memory module comprises a configuration register to store a command restore information and a command assembly unit connected to the first command port and to the second command port, wherein the command assembly unit is adapted to assemble the command data from the first and second command signals depending on the command restore information.

At least one of the memory devices of the memory module may include an initialization unit to receive initialization information including the command restore information. The initialization unit can define an operation mode wherein settings may be made to define the configuration register.

### BRIEF DESCRIPTION OF THE DRAWINGS

These and other aspects and features of the present invention will become clear from the following description taken in conjunction with the accompanying drawings in which:

FIG. 1 is a block diagram showing a memory module including a number of memory devices according to a first embodiment of the present invention;

FIG. 2 shows a block diagram of a memory module having a number of memory devices according to another embodiment of the present invention;

FIG. 3 shows a block diagram of a memory module having a number of memory devices according to yet another embodiment of the present invention; and

FIG. 4 shows a block diagram of a memory module having a number of memory devices according to yet another embodiment of the present invention.

### DETAILED DESCRIPTION OF THE PREFERRED EMBODIMENT

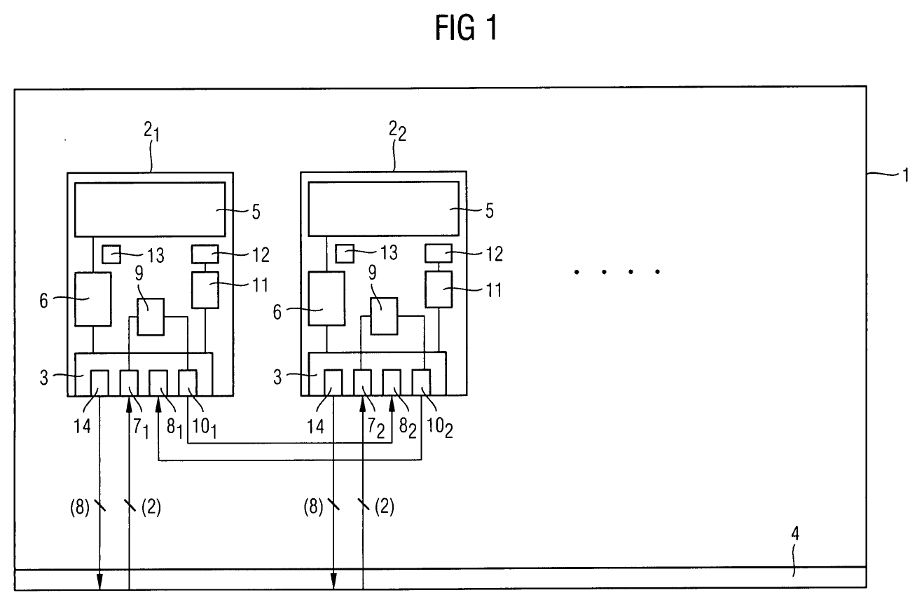

FIG. 1 shows a block diagram of a memory module 1 comprising a number of DRAM memory devices 2 providing a predetermined amount of memory. The memory devices 2 are preferably identical. The memory devices 2 each include a command interface 3 which is coupled to a module interface 4 via interconnection lines schematically depicted as arrows. Via the module interface 4, the memory module 1 can be connected to a memory controller (not shown) to provide point-to-point connection between respective parts of the memory controller and the parts of the memory devices 2.

Each of the memory devices 2 comprises a memory array 5, access to which can be controlled by a memory access logic 6 disposed in connection with the command interface 3. The memory access logic 6 controls the access to the memory array 5 depending on the command data received. The command interface 3 of each memory device 2 comprises a first command port 7 to receive a first command signal from the memory controller via the module interface 4 and a second command port 8 to receive a second command signal from another memory device 2 of the memory module 1. The command interface 3 further comprises a forwarding port 10 as an output port to forward the first command signal received via the first command port 7 as well as an application data port to input and output data. In one embodiment, the application data is supplied via a data bus (8 bit in width), and the command lines provided to each of the memory devices 2 are 2 bit in width.

The first command signal received by the first command port 7 is applied to a repeater unit 9 which forwards the first command signal to the forwarding port 10 immediately after receiving it. The forwarded first command signal is then transferred to the second command port 8 of another memory device 2.

The memory devices 2 of the memory module 1 shown in FIG. 1 are arranged in a pair-wise manner in which two of the memory devices 2 form a memory device pair wherein a first memory device 2₁ of the memory device pair is coupled to a second memory device 2₂ of the memory device pair in that the forwarding port 10₁ of the first memory device 2₁ of the respective memory device pair is coupled to the second command port 8₂ of the second memory device 2₂ of the respective memory device pair. Similarly, the forwarding port 10₂ of the second memory device 2₂ of the respective memory device pair is coupled to the second command port 8₁ of the first memory device 2₁ of the memory device pair. Thereby, command signals are received in one of the memory devices via the module interface 4 from, e.g., the memory controller (not shown) or from the respective other memory device of the memory device pair. Thereby, the number of command lines provided externally for each of the memory devices can be reduced as command signals received by one of the memory devices of each memory device pair are shared with the respective other memory device of the respective memory device pair.

The repeater unit 9 is designed to receive and recognize the first command signals from the first command port 7 and drive the first command signals to the forwarding port 10 of the respective memory device 2. A command assembly unit 11 is provided in each of the memory devices to assemble the command data from the first and second command signals received. Since the first command signals and the second command signals are different for each of the memory devices, a command restore information may be provided to the command assembly unit so that the command assembly unit is instructed on how to combine the first and second command signal to provide the correct command data. Command restore information can be stored in a configuration register 12 which is also provided in each of the memory devices 2.

Given as an example that the memory devices 2 are DRAM memory devices, command signals may include a RAS signal (Row-Activate-signal), a CAS signal (Column-Activate-signal), a WE signal (Write-Enable-signal) and a CKE signal (Clock-Enable-signal). In a given memory device pair in the memory module 1, a first memory device 2₁ may be configured to receive the RAS signal and the CAS signal while the second memory device 2₂ may be configured to receive the CKE signal and the WE signal. As such, the first memory device 2₁ receives the CKE signal and the WE signal via the second command port 8₁ and the RAS signal and CAS signal via the first command port 7₁. Vice versa, the second memory device 2₂ receives the RAS signal and the CAS signal via the second command port 8₂ and the CKE signal and the WE signal via the first command port 7₂ as mentioned above.

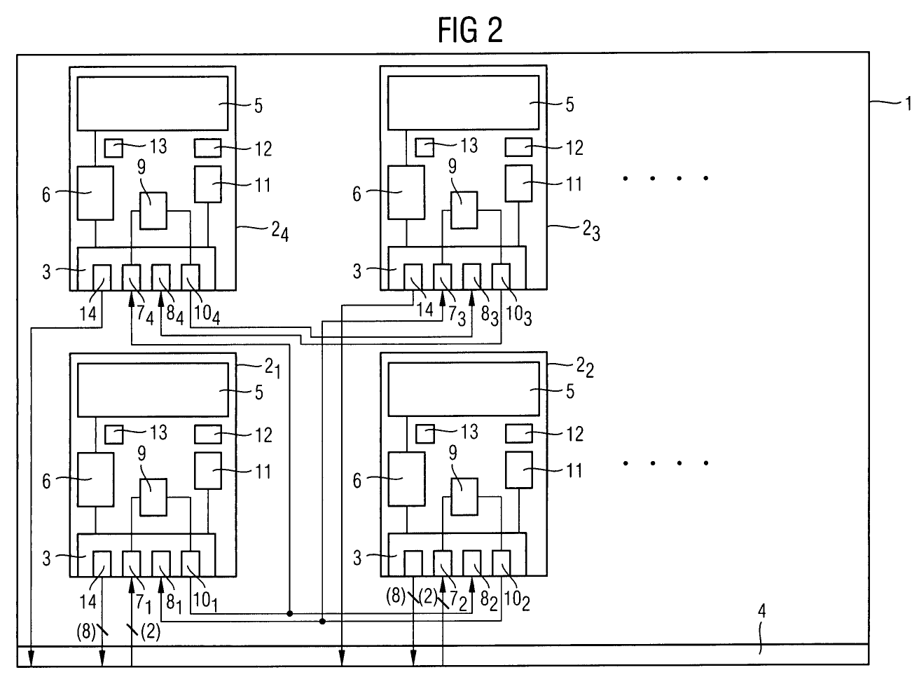

If the memory devices 2 are coupled in pairs, the number of command signals provided from the module interface 4 to each of the memory devices can be reduced to the half of the overall number of command signals. As shown in the embodiment of FIG. 2, a plurality of second command ports of respective memory devices can be connected to one forwarding port of one memory device 2. For instance, four memory devices may be coupled together to form a memory device group on the memory module 1 in the manner shown in FIG. 2. Maintaining the referencing of the embodiment of FIG. 1, the memory device group as shown further comprises a third memory device 2₃ and a fourth memory device 2₄, each having a first command port 7₃, 7₄, a second command port 8₃, 8₄, and a forwarding port 10₃, 10₄, respectively. The memory devices 2₁ to 2₄ are all of the same structure and normally designed identically. The forwarding port 10₁ of the first memory device 2₁ is coupled to the second command ports 8₂ of the second memory device 2₂ and the first command ports 7₄ of the fourth memory device 2₄, and the forwarding port 10₂ of the second memory device 2₂ is coupled to the second command port 8₁ of the first memory device 2₁ and to the first command port 7₃ of the third memory device 2₃. The forwarding port 10₃ of the third memory device 2₃ is coupled to the second command port 8₄ of the fourth memory device 2₄, and the forwarding port 10₄ of the fourth memory device 2₄ is coupled to the second command port 8₃ of the third memory device 2₃. If the length of the coupling lines between the four memory devices is reduced in length and the repeater units driving the command signals applied at the first command ports 7₁, 7₂, respectively, have sufficient driving capability, an appropriate or desired data rate in transferring the command signals between the memory devices can be achieved.

To provide the respective command restore information to the configuration register 12 of each of the memory devices 2, an initialization routine may be performed by means of an initialization unit 13 which is activated for the normal operation of the DRAM memory devices 2. When the initialization unit 13 is activated, the command restore information may be provided to the respective memory device 2 via the first command port 7 such that, depending on the data transferred via the first command port 7 of each of the memory devices 2, the configuration register 12 is set in the initialization mode so that the received command signals can be interpreted and assembled correctly.

In the embodiment of FIG. 2, the command signal lines between the memory controller and the memory module may be further reduced to one fourth of the number of command signals which would have to be applied without the sharing of the command signals between the memory devices in a memory device group. In such embodiment, each of the memory devices 2 of the memory device group is connected to an external command signal wherein each of the command signals represents a part of the command data to be provided for each of the memory devices. Each memory device forwards the respective received command signal to one or more of the other memory devices to share the respective command signal. For this purpose, each of the memory devices may include more than one second command port to receive command signals from other memory devices.

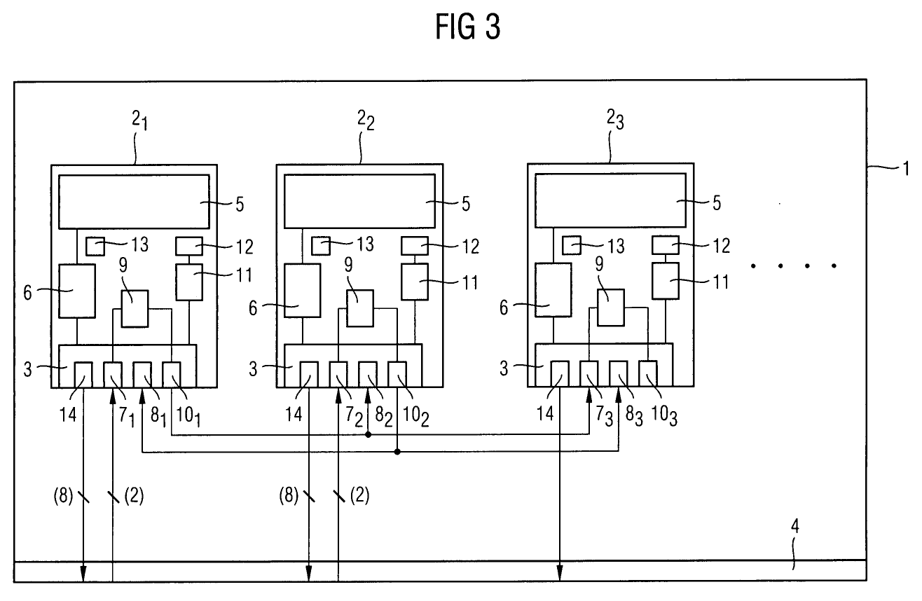

In another embodiment, one or more additional memory device may be provided for receiving command signals via the first and the second memory devices without being supplied with command signals provided by, e.g., the memory controller. Maintaining the referencing of the embodiment of FIG. 1, the memory device group as shown in FIG. 3 further comprises a third memory device 2₃ having a first command port 7₃ and a second command port 8₃. The third memory device 2₃ may optionally include a forwarding port 10₃, if forwarding of received signals is desired. The forwarding port 10₁ of the first memory device 2₁ is coupled to the second command port 8₂ of the second memory device 2₂ and the first command port 7₃ of the third memory device 2₃, and the forwarding port 10₂ of the second memory device 2₂ is coupled to the second command port 8₁ of the first memory device 2₁ and to the second command port 8₃ of the third memory device 2₃. As such, the third memory device 2₃ may receive command signals forwarded by the first and the second memory devices without being connected to receive command signals directly from the memory controller.

In another embodiment, four memory devices may be coupled together to form a memory device group on the memory module 1 in the manner shown in FIG. 4. Maintaining the referencing of the embodiment of FIG. 1, the memory device group as shown further comprises a third memory device 2₃ and a fourth memory device 2₄, each having a first command port 7₃, 7₄, a second command port 8₃, 8₄, and a forwarding port 10₃, 10₄, respectively. The memory devices 2₁ to 2₄ are all of the same structure and normally designed identically. The forwarding port 10₁ of the first memory device 2₁ is coupled to the respective second command ports 8₂, 8₄ of the second memory device 2₂ and the fourth memory device 2₄, and the forwarding port 10₂ of the second memory device 2₂ is coupled to the second command port 8₁ of the first memory device 2₁ and to the second command port 8₃ of the third memory device 2₃. The forwarding port 10₃ of the third memory device 2₃ is coupled to the first command port 7₄ of the fourth memory device 2₄, and the forwarding port 10₄ of the fourth memory device 2₄ is coupled to the first command port 7₃ of the third memory device 2₃. If the length of the coupling lines between the four memory devices is reduced in length and the repeater unit driving the command signals applied at the first command port 7₁ has a sufficient driving capability, an appropriate or desired data rate in transferring the command signals between the memory devices can be achieved.

Although the embodiments described above with respect to FIGS. 1-4 specify particular command signal forwarding schemes, other combinations and variations for forwarding received command signals from one device to one or more other devices in the memory module are contemplated. Furthermore, other arrangements or grouping of memory devices in a command signal forwarding scheme are also contemplated.

While the foregoing is directed to embodiments of the present invention, other and further embodiments of the invention may be devised without departing from the basic scope thereof, and the scope thereof is determined by the claims that follow.

What is claimed is:

1. A memory device for use in a memory module, comprising:
a memory array;
a memory access logic for controlling access to the memory array depending on a command data;
a command interface for establishing an interconnect to a memory controller and comprising a first command port and a second command port for receiving a first command signal and a second command signal indicating the command data;
a repeater unit for receiving the first command signal via the first command port and forwarding the first command signal to a forwarding port; and
the forwarding port for forwarding the received first command signal to one or more other memory devices in the memory module.

2. The memory device of claim 1, wherein the command interface comprises an address/data port for receiving an address and/or data information.

3. The memory device of claim 1, further comprising:
a configuration register for storing a command restore information; and
a command assembly unit for assembling the command data from the first and second command signals based on the command restore information.

4. The memory device of claim 3, further comprising:
a initialization unit configured to provide initialization information including the command restore information in an initialization process.

5. The memory device of claim 1, wherein the memory device is a dynamic random access memory (DRAM) device.

6. The memory device of claim 5, wherein the first and second command signals are assembled to form a DRAM command signal selected from Row-Activate-Signal, Column-Activate-Signal, Write-Enable-Signal and Chip-Select-Signal.

7. A memory module, comprising:
a plurality of memory devices, each memory device comprising:
a memory array;
a memory access logic for controlling access to the memory array depending on a command data;
a command interface for establishing an interconnect to a memory controller and comprising a first command port and a second command port for receiving a first command signal and a second command signal indicating the command data;
a repeater unit for receiving the first command signal via the first command port and forwarding the first command signal to a forwarding port; and
the forwarding port for forwarding the received first command signal to one or more other memory devices in the memory module; and
a first interconnection command line connecting the respective forwarding port of a first memory device to the respective second command port of a second memory device.

8. The memory module of claim 7, further comprising:
a second interconnection command line connecting the respective forwarding port of the second memory device to the respective second command port of the first memory device.

9. The memory module of claim 8, further comprising:
a module interface of the memory module for connecting the respective first command ports of the first and second memory devices to a memory controller.

10. The memory module of claim 8, wherein the first interconnection command line is further connected to the respective first command port of a third memory device.

11. The memory module of claim 10, wherein the second interconnection command line is further connected to the respective second command port of the third memory device.

12. The memory module of claim 8, wherein the first interconnection command line is further connected to the respective first command port of the third memory device and wherein the second interconnection command line is further connected to the respective first command port of a fourth memory device, and further comprising:
a third interconnection command line connected between the respective forwarding port of the third memory device to the respective second command port of the fourth memory device; and
a fourth interconnection command line connected between the respective forwarding port of the fourth memory device to the respective second command port of the third memory device.

13. The memory module of claim 7, wherein each memory device further comprises:
a configuration register for storing a command restore information; and
a command assembly unit for assembling the command data from the first and second command signals based on the command restore information.

14. The memory module of claim 13, wherein each memory device further comprises:
a initialization unit configured to provide initialization information including the command restore information in an initialization process.

15. The memory module of claim 7, wherein the memory module is configured as a dual in-line memory module (DIMM).

16. The memory module of claim 7, wherein the memory device is a dynamic random access memory (DRAM) device.

17. The memory module of claim 16, wherein the first and second command signals are assembled to form a DRAM command signal selected from Row-Activate-Signal, Column-Activate-Signal, Write-Enable-Signal and Chip-Select-Signal.

18. A method for communicating between a memory controller and a memory module, comprising:
sending a first command signal from the memory controller to a first command port of a first memory device of the memory module;
forwarding the first command signal from the first memory device to a second command port of a second memory device of the memory module;
sending a second command signal from the memory controller to a first command port of the second memory device; and
forwarding the second command signal from the second memory device to a second command port of the first memory device, wherein the first memory device receives the second command signal via forwarding by the second memory device and wherein the second memory device receives the first command signal via forwarding by the first memory device.

19. The method of claim 18, further comprising:
forwarding the first command signal from the first memory device to one or more other memory devices of the memory module; and
forwarding the second command signal from the second memory device to the one or more other memory devices of the memory module, wherein the one or more other memory devices receives the first and second command signals via forwarding by the first and second memory devices respectively.

20. The method of claim 18, further comprising:
forwarding the first command signal from the first memory device to a third memory device of the memory module;
forwarding the second command signal from the second memory device to a fourth memory device of the memory module; and
cross forwarding the respectively received first and second command signals between the third and fourth memory devices.
